(19) United States
(12) Patent Application Publication
(10) Pub. No.: US 2025/0130422 A1
(43) Pub. Date: Apr. 24, 2025

(54) IMAGE PROJECTION DEVICE

(71) Applicant: KOITO MANUFACTURING CO., LTD., Tokyo (JP)

(72) Inventors: Genki ADACHI, Shizuoka (JP); Hideaki YAMAMOTO, Shizuoka (JP)

(21) Appl. No.: 18/725,957

(22) PCT Filed: Jan. 5, 2023
(86) PCT No.: PCT/JP2023/000042

§ 371 Date: Jul. 1, 2024

(30) Foreign Application Priority Data
Jan. 18, 2022 (JP) 2022-006012

(51) Int. Cl. G02B 27/01; G03B 21/16; G03B 21/20

(52) U.S. Cl. CPC G02B 27/0101; G02B 27/0149; G02B 2027/0145; G02B 2027/0163; G03B 21/16; G03B 21/206

(57) ABSTRACT

Provided is an image projection device capable of suppressing a temperature increase in an image emission unit due to external light. An image projection device for emitting a projection image to a display unit for displaying a virtual image, which includes an image emission unit (20) that emits image light, a projection optical unit (40) that emits the image light as the projection image in a direction of a point of view via the display unit, and a shutter unit (30) that is disposed on an optical path for the image light between the image emission unit (20) and the display unit and switches between a transmission mode for transmitting light and a shielding mode for shielding light.

### TECHNICAL FIELD

The present invention relates to an image projection device, and more particularly to an image projection device that emits a projection image to a display unit for displaying a virtual image.

### BACKGROUND ART

Conventionally, an instrument panel that lights up and displays an icon has been used as a device that displays various types of information in a vehicle. With an increase in the amount of information to be displayed, it has also been proposed to incorporate an image display device into the instrument panel or to form the entire instrument panel by the image display device.

However, since the instrument panel is located below the windshield of the vehicle, it is not preferable for a driver to visually recognize the information displayed on the instrument panel because the driver needs to move the line of sight downward during driving. For this reason, there has also been proposed a head-up display (hereinafter referred to as HUD) that projects an image on a windshield to enable a driver to read information when the driver visually recognizes the image in front of a vehicle (see, e.g., Patent Literatures 1 and 2).

### CITATION LIST

### Patent Literature

Patent Literature 1: JP-A-2019-119248
Patent Literature 2: JP-A-2019-119262

### SUMMARY OF INVENTION

### Problems to be Solved by Invention

Such a conventional HUD device includes a projection optical system for emitting light upward from below the windshield in order to emit a projection image via the windshield as a display unit. Thus, when external light such as sunlight enters from above the windshield, the external light reaches an image emission unit that displays an image via the projection optical system. At this time, the external light reaching the image emission unit via the projection optical system is condensed by the optical power of the projection optical system, leading to a problem that the external light causes deterioration due to a temperature increase.

In order to suppress such a temperature increase, it has also been proposed to dispose a wavelength cut filter on an optical path for the projection optical system to cut infrared light and ultraviolet light contained in the external light. However, it is inevitable that visible light contained in the external light passes through the wavelength cut filter and reaches the display unit, and since the light transmittance of the wavelength cut filter is not 100%, the light emitted from the display unit is also partially attenuated, which may cause a decrease in luminance in image projection.

Thus, the present invention has been made in view of the above-described conventional problems, and an object thereof is to provide an image projection device capable of suppressing a temperature increase in an image emission unit due to external light.

### Solution to Problems

In order to solve the above-described problems, the image projection device of the present invention is an image projection device for emitting a projection image to a display unit for displaying a virtual image, the image projection device including an image emission unit that emits image light, a projection optical unit that emits the image light as the projection image in a direction of a point of view via the display unit, and a shutter unit that is disposed on an optical path for the image light between the image emission unit and the display unit and switches between a transmission mode for transmitting light and a shielding mode for shielding light.

In the image projection device of the present invention, since the shutter unit is switched between transmission and shielding of light, it is possible to appropriately select the transmission mode in which the image light from the image emission unit is transmitted and the image is projected and the shielding mode in which external light is shielded and a temperature increase in the image emission unit is suppressed, allowing suppression of a temperature increase in the image emission unit due to the external light.

In one aspect of the present invention, the image emission unit emits the image light by pulse drive for repeated light ON and OFF, and in the shutter unit, the transmission mode is selected during an ON period of the pulse drive and the shielding mode is selected during an OFF period of the pulse drive.

In one aspect of the present invention, the shutter unit includes a rotating body having a light transmission unit and a light shielding unit, and a drive unit that rotationally drives the rotating body.

In one aspect of the present invention, the shutter unit is disposed between the image emission unit and the projection optical unit.

In one aspect of the present invention, the projection optical unit forms an image from the image light at an intermediate image forming position on the optical path, and the shutter unit is disposed at the intermediate image forming position.

In one aspect of the present invention, the image emission unit includes a first irradiation area irradiated with a first image and a second irradiation area irradiated with a second image, and the shutter unit selects the transmission mode or the shielding mode for each of the first irradiation area and the second irradiation area.

### Effects of Invention

According to the present invention, the image projection device capable of suppressing a temperature increase in the image emission unit due to external light can be provided.

### BRIEF DESCRIPTION OF DRAWINGS

FIG. 1 is a block diagram illustrating the configuration of an image projection device 100 according to a first embodiment of the present invention;

FIG. 2 is a schematic sectional view illustrating a configuration example of the image projection device 100 according to the first embodiment;

FIG. 3 is a schematic plan view illustrating one example of a shutter unit 30 according to the first embodiment;

FIGS. 4(a) to 4(c) are schematic views for describing a transmission mode and a shielding mode by the shutter unit 30, FIG. 4(a) illustrating a display area in an image emission unit 20, FIG. 4(b) illustrating the transmission mode, and FIG. 4(c) illustrating the shielding mode;

FIGS. 5(a) and 5(b) are timing charts according to a modification of the first embodiment, FIG. 5(a) illustrating opening/closing timing of the shutter unit 30 and FIG. 5(b) illustrating ON/OFF timing of a light source unit 10;

FIGS. 6(a) to 6(d) are schematic views illustrating the configuration of a shutter unit 30 and a relationship with an image emission unit 20 according to a second embodiment, FIG. 6(a) illustrating a full transmission mode, FIG. 6(b) illustrating a far shielding mode, FIG. 6(c) illustrating a full shielding mode, and FIG. 6(d) illustrating a near shielding mode;

FIGS. 7(a) and 7(b) are views illustrating a configuration example of an image projection device 100 according to a third embodiment, FIG. 7(a) being an overall schematic sectional view and FIG. 7(b) being a schematic perspective view of one example of a shutter unit 30; and

FIGS. 8(a) and 8(b) are schematic views illustrating a configuration example of a shutter unit 30 according to a fourth embodiment, FIG. 8(a) illustrating a configuration example of a substantially rectangular type and FIG. 8(b) illustrating a configuration example where a shielding mode is provided only for a partial area.

### DESCRIPTION OF EMBODIMENTS

### First Embodiment

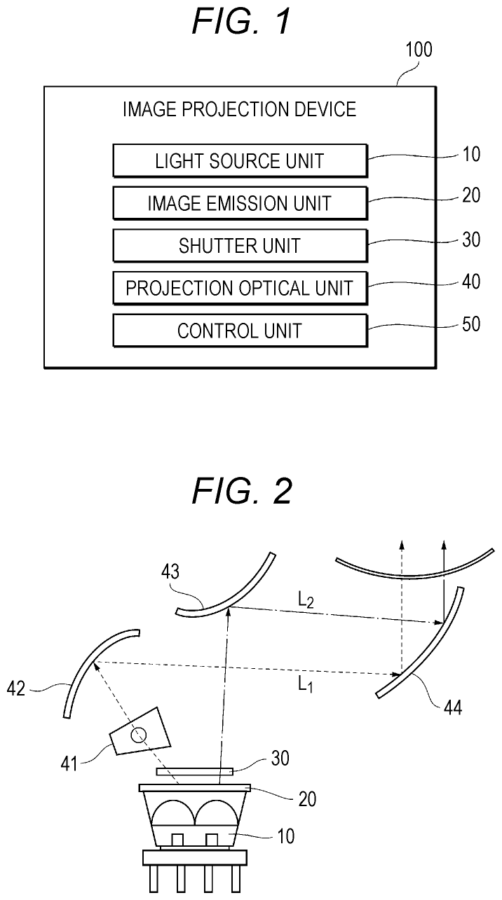

Hereinafter, embodiments of the present invention will be described in detail with reference to the drawings. The same or equivalent components, members, and processes illustrated in the drawings are denoted by the same reference numerals, and overlap description thereof will be omitted as necessary. FIG. 1 is a block diagram illustrating the configuration of an image projection device 100 according to the present embodiment. As illustrated in FIG. 1, the image projection device 100 includes a light source unit 10, an image emission unit 20, a shutter unit 30, a projection optical unit 40, and a control unit 50. Light projected from the image projection device 100 is emitted to a position of a point of view of a driver via a not-illustrated windshield (display unit).

The light source unit 10 is a light source that emits light to the image emission unit 20. Light emission from the light source unit 10 may be constant light emission, but is preferably one subjected to pulse width modulation (PWM) control according to a control signal from the control unit 50 as described later. A specific configuration of the light source unit 10 is not limited, but, e.g., a light emitting diode (LED) or an organic EL element can be used.

The image emission unit 20 is a unit that emits light (image light) including an image based on image information from the control unit 50. A specific configuration of the image emission unit 20 is not limited, and a conventionally-known configuration such as a liquid crystal display device, an organic EL display device, or a combination of a laser light source and a light modulation element can be used. In an example illustrated in FIG. 1, light is emitted from the light source unit 10 from the back side of the liquid crystal display device. As described later, the image emission unit 20 may include a near display area 22 and a far display area 23 for displaying a near image and a far image, respectively.

The shutter unit 30 is a unit that switches between a transmission mode for transmitting light and a shielding mode for shielding light according to a control signal from the control unit 50. The configuration of the shutter unit 30 is not limited, but, e.g., a liquid crystal shutter capable of changing the transmittance of light according to an electric signal, a digital mirror device that switches the reflection direction of light, or a mechanical shutter that mechanically switches between an opening and a light shielding unit can be used. When the mechanical shutter is used as the shutter unit 30, a mechanism for operating a light shielding plate of the shutter unit 30 and a drive unit may be provided in the shutter unit 30. Since the shutter unit 30 includes the light shielding unit that shields external light, the temperature of the shutter unit 30 itself is likely to increase due to the shielded external light. Thus, the shutter unit 30 is preferably made of a metal material having high thermal conductivity.

The projection optical unit 40 is an optical member for emitting the image light from the image emission unit 20 to the windshield as the display unit. The projection optical unit 40 may include a plurality of optical members, or may include, e.g., a plurality of lenses, concave mirrors, convex mirrors, or prisms or a combination thereof. An image may be formed from the image light from the image emission unit 20 at the same distance on one optical path, or may be split into a plurality of optical paths and formed at a plurality of focal lengths.

The control unit 50 is a unit that is connected to each unit such that information is communicable therebetween and controls each unit. The configuration of the control unit 50 is not limited, and examples thereof include a central processing unit (CPU) for performing information processing and one including, e.g. a memory device, a recording medium, or an information communication device. The control unit 50 controls operation of each unit according to a predetermined program, and sends information (image information) including an image to the image emission unit 20.

FIG. 2 is a schematic sectional view illustrating a configuration example of the image projection device 100 according to the present embodiment. In an example illustrated in FIG. 2, a transmissive liquid crystal display device is disposed as the image emission unit 20 on a light emission surface of the light source unit 10 having the LED, and the shutter unit 30 is disposed so as to face a light output surface of the image emission unit 20. A specific configuration example of the shutter unit 30 will be described later. In the example illustrated in FIG. 2, the projection optical unit 40 includes a light splitting unit 41, a free-form surface mirror 42, a reflecting mirror 43, and a free-form surface mirror 44.

The light splitting unit 41 is an optical member that splits image light emitted from the image emission unit 20, and splits the image light at least into first image light L1 as a first image displayed in a far display area 23 and second image light L2 as a second image displayed in a near display area 22. The shutter unit 30 is disposed between the light splitting unit 41 and the image emission unit 20. The structure of the light splitting unit 41 is not limited as long as the light splitting unit 41 is an optical member that splits light, and a prism may be used or a technique of making an incident angle and a reflection angle of light different by a reflecting mirror may be used. In the example illustrated in FIG. 2, the prism is used as the light splitting unit 41, and is disposed so as to overlap with the far display area 23 of the image emission unit 20.

Here, disposing the light splitting unit 41 so as to overlap with the image emission unit 20 means that an area where the light splitting unit 41 is disposed overlaps with an image display area of the image emission unit 20 in plan view. Thus, the first image light L1 emitted from the far display area 23 is reflected by the free-form surface mirror 42 on a path different from that for the second image light L2 by the light splitting unit 41 and reaches the free-form surface mirror 44. The second image light L2 emitted from the near display area 22 is reflected by the reflecting mirror 43 and reaches the free-form surface mirror 44.

The first image light L1 and the second image light L2 having reached the free-form surface mirror 44 are reflected upward, and reach the not-illustrated windshield. Then, these lights are reflected by the windshield, and enters the point of view of a passenger. In the projection optical unit 40, a convex lens or a concave lens may be disposed as necessary to enlarge or reduce a light diameter. The arrangement and orientation of the light splitting unit 41, the free-form surface mirror 42, the reflecting mirror 43, and the free-form surface mirror 44 are not limited to those illustrated in FIG. 2. A shielding plate that shields external light may be separately disposed on the optical path for the first image light L1 and/or the optical path for the second image light L2 as necessary.

The free-form surface mirror 42 is an optical member into which the first image light L1 enters through the light splitting unit 41 and which reflects the first image light L1 toward the free-form surface mirror 44. A reflecting surface of the free-form surface mirror 42 is designed to enlarge the light diameter in a direction of the point of view of the driver in order to project the first image light L1 as a virtual image through the windshield. Here, enlarging the light diameter in the direction of the point of view includes not only a case where the light diameter is consistently enlarged after reflection, but also a case where the light diameter is reduced, an image is formed at an intermediate point, and then the light diameter is enlarged.

The reflecting mirror 43 is an optical member into which the second image light L2 emitted from the image emission unit 20 enters and which reflects the second image light L2 toward the free-form surface mirror 44. In the example illustrated in FIG. 2, a convex mirror is illustrated as the reflecting mirror 43, but an optically-designed mirror necessary for projecting the second image light L2 as the virtual image can be used, and as necessary, e.g., a concave mirror, a flat mirror, or a free-form surface mirror can be used. Alternatively, the reflecting mirror 43 may be omitted, and the second image light L2 from the image emission unit 20 may directly enter the free-form surface mirror 44.

The free-form surface mirror 44 is a concave mirror into which the first image light L1 and the second image light L2 enter and which reflects the first image light L1 and the second image light L2 toward the windshield. A reflecting surface of the free-form surface mirror 44 is designed to enlarge the light diameter in the direction of the point of view of a driver in order to project the first image light L1 and the second image light L2 as virtual images through the windshield. Here, enlarging the light diameter in the direction of the point of view includes not only a case where the light diameter is consistently enlarged after reflection, but also a case where the light diameter is reduced, an image is formed at an intermediate point, and then the light diameter is enlarged.

The windshield (not illustrated) is a component provided in front of a driver's seat of a vehicle and transmits visible light. The windshield reflects, on the surface in the vehicle, the first image light L1 and the second image light L2 having entered from the free-form surface mirror 44 in the direction of the point of view, and transmits light from the outside of the vehicle in the direction of the point of view. Thus, the windshield is equivalent to the display unit in the present invention. Although the example where the windshield is used as the display unit has been described here, a combiner may be prepared as a display unit separately from the windshield, and the light from the free-form surface mirror 44 may be reflected in the direction of the point of view. In addition, the windshield is not limited to one located in front of the vehicle, and may be disposed at the side or back as long as an image is projected with respect to the point of view of the passenger.

The virtual image is an image displayed as if an image is formed from the first image light L1 and the second image light L2 in the air when the first image light L1 and the second image light L2 reflected by the windshield reach the point of view (eye box) of, e.g., the driver. A position at which the virtual image is formed is determined by a divergence angle when the light emitted from the image emission unit 20 travels in the direction of the point of view after having been reflected by the free-form surface mirror 42, the reflecting mirror 43, the free-form surface mirror 44, and the windshield.

In the image projection device 100 illustrated in FIG. 2, the prism which is the light splitting unit 41 is disposed at the position overlapping with the far display area 23, and the path is split into the path for the first image light L1 from the far display area 23 and the path for the second image light L2 from the near display area 22. The first image displayed in the far display area 23 reaches the point of view of the passenger through the light splitting unit 41, the free-form surface mirror 42, the free-form surface mirror 44, and the windshield. The second image displayed in the near display area 22 reaches the point of view of the passenger through the reflecting mirror 43, the free-form surface mirror 44, and the windshield. Since the light diameters of the first image light L1 and the second image light L2 are enlarged by the projection optical unit 40 and reach the point of view, the passenger visually recognizes that the virtual images of the first image and the second image light formed from the first image light L1 and the second image light L2 are formed at a predetermined distance. Here, as for the virtual image forming position, the first image is farther from the position of the point of view than the second image.

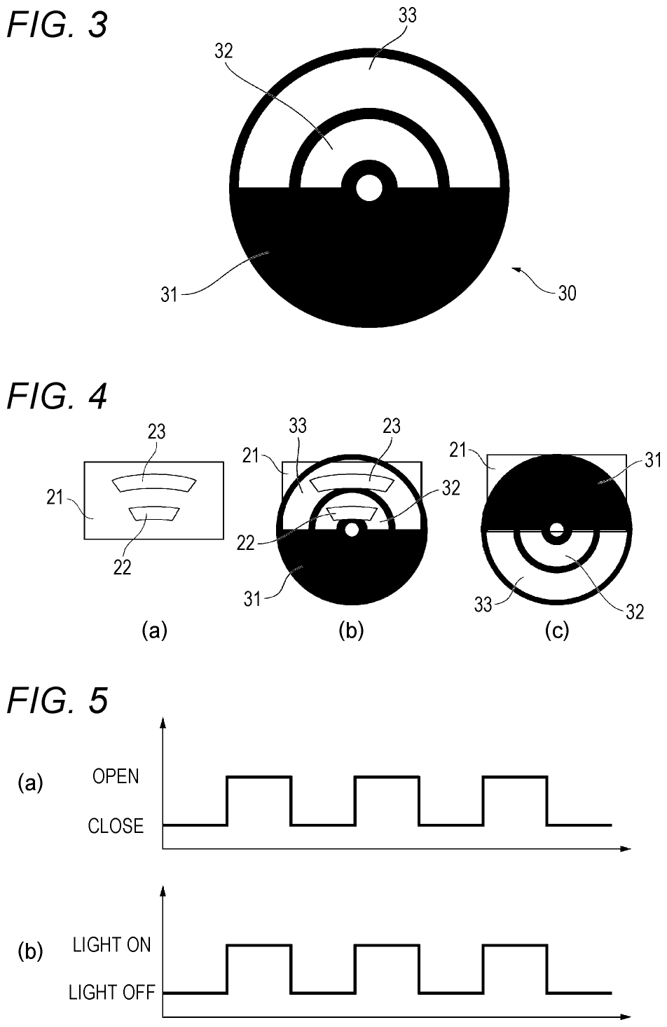

FIG. 3 is a schematic plan view illustrating one example of the shutter unit 30 according to the present embodiment. In the example illustrated in FIG. 3, the shutter unit 30 is a rotating body formed of a substantially circular flat plate-shaped member, and is provided with a light shielding unit 31, a near opening 32, and a far opening 33. The light shielding unit 31 is made of a material that shields light, and is a unit that shields the first image light L1, the second image light L2, and external light having reached the light shielding unit 31. The near opening 32 is an opening provided at a position overlapping with the near display area 22. The far opening 33 is an opening provided at a position overlapping with the far display area 23. Since the near opening 32 and the far opening 33 are the openings provided in the shutter unit 30, these openings transmit light and are equivalent to a light transmission unit in the present invention. Here, the near opening 32 and the far opening 33 are described as the openings as the light transmission unit. However, the shutter unit 30 may be made of a light-transmitting material and the light shielding unit 31 may be formed with a light shielding layer which does not transmit light, and an area where the light shielding layer is not formed may be taken as a light transmission unit.

Further, the shutter unit 30 includes a motor unit (not illustrated) as a drive unit, and rotates at a predetermined rotation speed according to a control signal from the control unit 50 so that the mode can be switched between the transmission mode and the shielding mode. A mechanism for rotationally driving the shutter unit 30 by the motor unit is not limited, and a center shaft of the shutter unit 30 may be directly coupled to a rotary shaft of the motor unit, or the shutter unit 30 may be driven via some kind of gear mechanism. Alternatively, a rotating body may be brought into contact with the outer periphery of the shutter unit 30, and the shutter unit 30 may be indirectly rotated by rotating the rotating body with the motor unit. Although the configuration of the motor unit is not limited, a rotation speed and a phase can be controlled using a stepping motor, and therefore, the mode of the shutter unit 30 can be accurately switched between the transmission mode and the shielding mode.

FIGS. 4(a) to 4(c) are schematic views for describing the transmission mode and the shielding mode by the shutter unit 30. FIG. 4(a) illustrates a display area in the image emission unit 20, FIG. 4(b) illustrates the transmission mode, and FIG. 4(c) illustrates the shielding mode. As illustrated in FIG. 4(a), the near display area 22 and the far display area 23 are provided at different positions in an entire display area 21 of the image emission unit 20. When an area for displaying an image in the entire display area 21 includes only the near display area 22 and the far display area 23, a light shielding member may be provided in the entire display area 21 and openings corresponding to the near display area 22 and the far display area 23 may be formed.

The near display area 22 is an area irradiated with the second image light L2 including a near image visually recognized as being formed at a position relatively near the passenger, and is equivalent to a second irradiation area in the present invention. The far display area 23 is an area irradiated with the first image light L1 including a far image visually recognized as being formed at a position relatively far from the passenger, and is equivalent to a first irradiation area in the present invention. As described above, the first image light L1 and the second image light L2 are respectively reflected by the projection optical unit 40 and the windshield, and reach the point of view of the passenger. Thus, the near display area 22 and the far display area 23 on the image emission unit 20 are areas that are distorted as illustrated in FIG. 4(a) so as to form rectangular virtual images after reflection on the windshield.

As illustrated in FIG. 4(b), in the transmission mode of the shutter unit 30, the near opening 32 overlaps with the near display area 22, and the far opening 33 overlaps with the far display area 23. Thus, the second image light L2 emitted from the near display area 22 passes through the near opening 32, enters the light splitting unit 41, is reflected by the free-form surface mirror 42, the free-form surface mirror 44, and the windshield, and forms the near image as a virtual image. Similarly, the first image light L1 emitted from the far display area 23 passes through the far opening 33, enters the reflecting mirror 43, is reflected by the free-form surface mirror 44 and the windshield, and forms the far image as a virtual image. At this time, since the first image light L1 and the second image light L2 pass through the near opening 32 and the far opening 33 having high transmittance, the amount of attenuated light is reduced, and the luminance of the projected virtual image can be increased.

Here, the near opening 32 and the far opening 33 have fan shapes having curvatures along a circumferential direction in the disk-shaped shutter unit 30. Thus, as illustrated in FIG. 4(b), the shutter unit 30 is preferably disposed such that the curving directions of the near opening 32 and the far opening 33 coincide with the distortion directions of the near display area 22 and the far display area 23. Since the far display area 23 is often larger in area than the near display area 22, the near opening 32 is preferably provided on the inner peripheral side and the far opening 33 is preferably provided on the outer peripheral side in the disk-shaped shutter unit 30.

As illustrated in FIG. 4(c), in the shielding mode of the shutter unit 30, the light shielding unit 31 overlaps with the near display area 22 and the far display area 23. Thus, external light having reached the shutter unit 30 from the windshield via the projection optical unit 40 is shielded by the light shielding unit 31 and does not reach the image emission unit 20. With this configuration, the amount of external light reaching the image emission unit 20 can be reduced, and a temperature increase in and deterioration of the image emission unit 20 can be suppressed.

As described above, in the image projection device 100 of the present embodiment, since the shutter unit 30 is switched between transmission and shielding of light, it is possible to appropriately select the transmission mode in which the image light from the image emission unit 20 is transmitted and the image is projected and the shielding mode in which external light is shielded and a temperature increase in the image emission unit 20 is suppressed, allowing suppression of a temperature increase in the image emission unit 20 due to external light.

### Modification of First Embodiment

Next, a modification of the first embodiment of the present invention will be described with reference to FIG. 5. Description of contents overlapping with those of the first embodiment will be omitted. The present modification is different from the first embodiment in that the light source unit 10 is pulse-driven by the PWM control in order to save power and is repeatedly turned on and off at a predetermined duty ratio. FIG. 5 illustrates timing charts according to the present modification. FIG. 5(a) illustrates opening/closing timing of the shutter unit 30, and FIG. 5(b) illustrates ON/OFF timing of the light source unit 10.

As illustrated in FIGS. 5(a) and 5(b), the shutter unit 30 is in a closed state, i.e., the shielding mode at the OFF timing of the light source unit 10, and is in an open state, i.e., in the transmission mode at the ON timing of the light source unit 10. By switching the shutter unit 30 between the transmission mode and the shielding mode as illustrated in FIGS. 4(b) and 4(c), opening and closing can be switched as illustrated in FIG. 5(a). At this time, rotation of the motor unit may be controlled by the control unit 50 to rotate the shutter unit 30 only at the time of switching opening and closing, or the shutter unit 30 may be continuously rotated at a constant speed.

Since light is not emitted from the light source unit 10 at the OFF timing of the light source unit 10, an image displayed on the image emission unit 20 is also not projected as a virtual image. Thus, by synchronizing the OFF timing of the light source unit 10 and the shielding mode of the shutter unit 30, external light does not reach the image emission unit 20 during a time period in which the external light does not contribute to projection of the virtual image, and it is possible to suppress a temperature increase in and deterioration of the image emission unit 20 due to the external light.

Since light is emitted from the light source unit 10 at the ON timing of the light source unit 10, an image displayed on the image emission unit 20 is projected as a virtual image. Thus, by synchronizing the ON timing of the light source unit 10 and the transmission mode of the shutter unit 30, the first image light L1 and the second image light L2 are projected without being attenuated during a time period in which such light contributes to projection of the virtual image, and the luminance of the virtual image to be projected can be improved.

FIG. 5 illustrates an example where a duty ratio which is a ratio of the ON time of the light source unit 10 in the entire time is set to 50%, but the luminance may be adjusted by changing the duty ratio of the light source unit 10. In this case, the duty ratio is preferably changed in a range in which the ON period of the light source unit 10 is included in the period of the transmission mode of the shutter unit 30.

In the shutter unit 30 illustrated in FIG. 3, the duty ratio for opening and closing is 50% by providing the light shielding unit 31 in an angle range of 180 degrees. However, when the transmission mode and the shielding mode are repeated by rotating the shutter unit 30 at a constant rotation speed, the duty ratio may be set by changing the range in which the light shielding unit 31 is provided. As one example, when the light shielding unit 31 is provided in a range of 90 degrees and the near opening 32 and the far opening 33 are provided in a range of 270 degrees, the duty ratio for opening and closing can be set to 75%.

In the example illustrated in FIGS. 5(a) and 5(b), the timing at which opening and closing of the shutter unit 30 are switched and the timing at which the light source unit 10 is turned on and off coincide with each other. However, the timings may be selected so as to overlap with each other such that the transmission mode is included during the ON period and the shielding mode is included during the OFF period.

As described above, in the image projection device 100 of the present modification, the image emission unit 20 emits the image light by pulse drive of the light source unit 10 repeatedly turned on and off, and the shutter unit 30 selects the transmission mode during the ON period and selects the shielding mode during the OFF period. With this configuration, it is possible to improve the luminance in the transmission mode while suppressing a temperature increase in and deterioration of the image emission unit 20 due to external light in the shielding mode.

### Second Embodiment

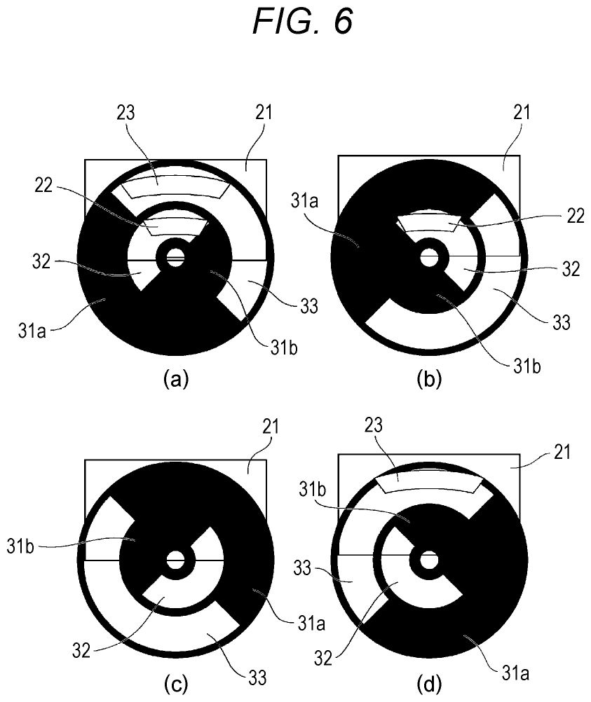

Next, a second embodiment of the present invention will be described with reference to FIG. 6. Description of contents overlapping with those of the first embodiment will be omitted. The present embodiment is different from the first embodiment in that transmission and shielding of the first image light L1 and the second image light L2 are individually set. FIG. 6 illustrates schematic views of the configuration of the shutter unit 30 and a relationship with the image emission unit 20 according to the present embodiment. FIG. 6(a) illustrates a full transmission mode, FIG. 6(b) illustrates a far shielding mode, FIG. 6(c) illustrates a full shielding mode, and FIG. 6(d) illustrates a near shielding mode.

As illustrated in FIGS. 6(a) to 6(d), in the shutter unit 30 of the present embodiment, the near opening 32 and the far opening 33 are provided at positions different from each other by 90 degrees. Similarly, the light shielding unit 31 includes a far light shielding unit 31a and a near light shielding unit 31b, and the far light shielding unit 31a and the near light shielding unit 31b are provided at positions different from each other by 90 degrees.

In the full transmission mode illustrated in FIG. 6(a), the near opening 32 overlaps with the near display area 22, and the far opening 33 overlaps with the far display area 23. Thus, since the first image light L1 and the second image light L2 pass through the near opening 32 and the far opening 33 having high transmittance, the amount of attenuated light is reduced, and the luminance of the projected virtual image can be increased.

In the far shielding mode illustrated in FIG. 6(b), the near opening 32 overlaps with the near display area 22, and the far light shielding unit 31a overlaps with the far display area 23. Thus, since the second image light L2 from the near display area 22 passes through the near opening 32 having high transmittance, the amount of attenuated light is reduced, and the luminance of the projected virtual image can be increased. In addition, since a temperature increase in the image emission unit 20 due to external light tends to be noticeable in the far display area 23, a temperature increase in the far display area 23 can be effectively suppressed by the control unit 50 selecting the far shielding mode.

In the full shielding mode illustrated in FIG. 6(c), the near light shielding unit 31b overlaps with the near display area 22, and the far light shielding unit 31a overlaps with the far display area 23. Thus, external light having reached the shutter unit 30 from the windshield via the projection optical unit 40 is shielded by the near light shielding unit 31b and the far light shielding unit 31a and does not reach the image emission unit 20. With this configuration, the amount of external light reaching the image emission unit 20 can be reduced, and a temperature increase in and deterioration of the image emission unit 20 can be suppressed.

In the near shielding mode illustrated in FIG. 6(d), the near light shielding unit 31b overlaps with the near display area 22, and the far opening 33 overlaps with the far display area 23. Thus, since the first image light L1 from the far display area 23 passes through the far opening 33 having high transmittance, the amount of attenuated light is reduced, and the luminance of the projected virtual image can be increased. A temperature increase in the near display area 22 can be effectively suppressed by the control unit 50 selecting the near shielding mode.

As described above, in the image projection device 100 according to the present embodiment, the control unit 50 selects the shielding mode of the shutter unit 30 according to the area where a temperature increase is desired to be suppressed in the image emission unit 20 and the display area of the virtual image to be projected, for which the luminance is desired to be increased, allowing suppression of a temperature increase and improvement in the luminance of the image emission unit 20 in response to various situations.

### Third Embodiment

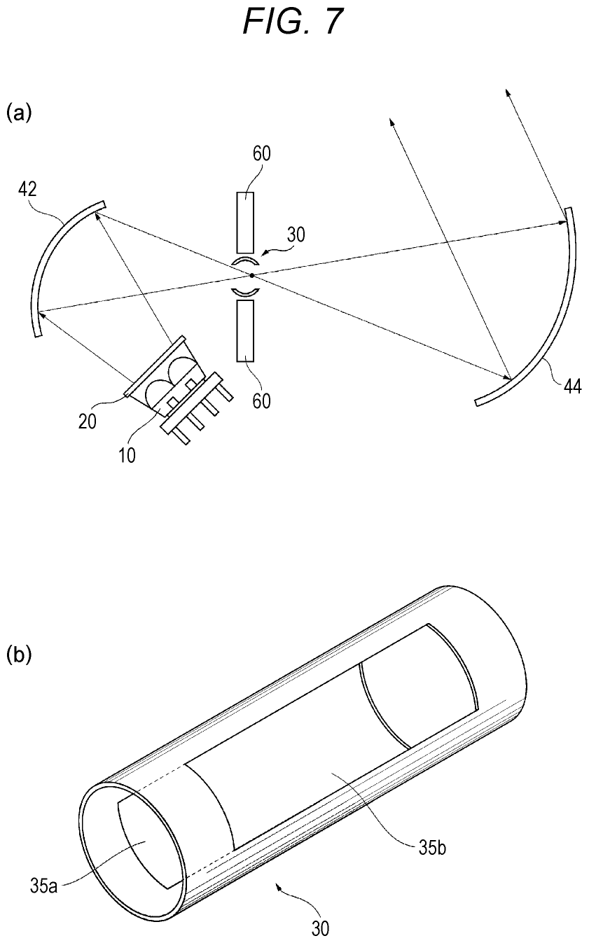

Next, a third embodiment of the present invention will be described with reference to FIG. 7. Description of contents overlapping with those of the first embodiment will be omitted. The present embodiment is different from the first embodiment in that an image is intermediately formed from the image light in the projection optical unit 40 and the shutter unit 30 is disposed at the intermediate image forming position. FIG. 7 illustrates views of a configuration example of the image projection device 100 according to the present embodiment. FIG. 7(a) is an overall schematic sectional view, and FIG. 7(b) is a schematic perspective view illustrating one example of the shutter unit 30.

As illustrated in FIGS. 7(a) and 7(b), the image projection device 100 of the present embodiment includes the light source unit 10, the image emission unit 20, the shutter unit 30, and an external light shielding unit 60. The free-form surface mirror 42 and the free-form surface mirror 44 are provided as the projection optical unit 40. The image light emitted from the image emission unit 20 is reflected by the free-form surface mirror 42 and the free-form surface mirror 44, reaches the windshield, and is projected in the direction of the point of view of a passenger. At least a uniaxial component of the image light reflected by the free-form surface mirror 42 is condensed at the intermediate image forming position before reaching the free-form surface mirror 44, and after having been condensed at the intermediate image forming position, reaches the free-form surface mirror 44 while being enlarged.

The external light shielding unit 60 is a member made of a light-shielding material and provided with an opening at the intermediate image forming position. By disposing the external light shielding unit 60 at the intermediate image forming position, it is possible to shield a component of external light not reaching the image emission unit 20 among external light having entered from the windshield and to prevent generation of stray light.

As illustrated in FIGS. 7(a) and 7(b), the shutter unit 30 is made of a light-shielding material and is formed in a substantially cylindrical shape. Openings 35a, 35b are provided in the side surface of the shutter unit 30 at positions facing each other. The side surface of the shutter unit 30 is equivalent to a light shielding unit in the present invention, and the openings 35a, 35b are equivalent to a light transmission unit in the present invention.

The shutter unit 30 is disposed at the intermediate image forming position of the free-form surface mirror 42 so that the image light from which the image is intermediately formed can pass through the openings 35a, 35b. In addition, the shutter unit 30 is rotationally driven by the drive unit with the center axis of the cylinder as a rotation axis, and the positions of the side surface and the openings 35a, 35b can be switched. Thus, the shielding mode is set when the side surface of the shutter unit 30 is located on the optical path for the image light, and the transmission mode is set when the openings 35a, 35b are located.

Also in the image projection device 100 of the present embodiment, since the shutter unit 30 is switched between transmission and shielding of light, it is possible to appropriately select the transmission mode in which the image light from the image emission unit 20 is transmitted and the image is projected and the shielding mode in which external light is shielded and a temperature increase in the image emission unit 20 is suppressed, allowing suppression of a temperature increase in the image emission unit 20 due to external light. Further, since the shutter unit 30 is provided at the intermediate image forming position, it is possible to reduce the shutter unit 30 and the image projection device 100 in size and weight.

### Fourth Embodiment

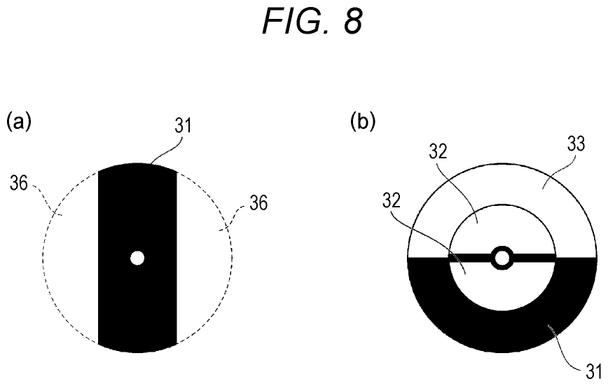

Next, a fourth embodiment of the present invention will be described with reference to FIG. 8. Description of contents overlapping with those of the first embodiment will be omitted. FIG. 8 illustrates schematic views of a configuration example of the shutter unit 30 according to the present embodiment. FIG. 8(a) illustrates a configuration example of a substantially rectangular type, and FIG. 8(b) illustrates a configuration example where the shielding mode is provided only for a partial area.

In the shutter unit 30 illustrated in FIG. 8(a), part of a disk shape is cut out, a cutout portion 36 is provided as a light transmission unit, and the remaining substantially rectangular portion is provided as a light shielding unit 31. Even with such a simple shape, it is possible to switch between the cutout portion 36 as the light transmission unit and the light shielding unit 31 by rotary drive.

In the shutter unit 30 illustrated in FIG. 8(b), the near opening 32 is provided over 360 degrees on the inner peripheral side of the disk shape, and the far opening 33 is provided over 180 degrees on the outer peripheral side. Since a temperature increase in the image emission unit 20 due to external light tends to be noticeable in the far display area 23, a temperature increase in and deterioration of the far display area 23 can be effectively suppressed by switching between the shielding mode and the transmission mode only for the far display area 23. In addition, since the light shielding unit 31 is not provided for the near display area 22 and the near display area 22 is always in the transmission mode, the luminance of the near image can be improved.

The present invention is not limited to each of the above-described embodiments, and various changes can be made within the scope of the claims, and embodiments obtained by appropriately combining techniques disclosed in different embodiments are also included in the technical scope of the present invention.

The present international application claims priority based on Japanese Patent Application No. 2022-006012 filed on Jan. 18, 2022, and the entire contents of Japanese Patent Application No. 2022-006012 are incorporated herein by reference.

The description of the specific embodiments of the present invention is presented for the purpose of illustration. The specific embodiments are not intended to be exhaustive or to limit the invention as it is in the form described. It is obvious to those skilled in the art that many modifications and alterations are possible in light of the contents of the description above.

### LIST OF REFERENCE SIGNS

100 IMAGE PROJECTION DEVICE
10 Light source unit
20 Image emission unit
30 Shutter unit
40 Projection optical unit
50 Control unit
60 External light shielding unit
21 Full display area
22 Near display area
23 Far display area
31 Light shielding unit
31a Far light shielding unit
31b Near light shielding unit
32 Near opening
33 Far opening
35a, 35b Opening
36 Cutout portion
41 Light splitting unit
42, 44 Free-form surface mirror
43 Reflecting mirror

1. An image projection device for emitting a projection image to a display unit for displaying a virtual image, comprising:
an image emission unit that emits image light;
a projection optical unit that emits the image light as the projection image in a direction of a point of view via the display unit; and
a shutter unit that is disposed on an optical path for the image light between the image emission unit and the display unit and switches between a transmission mode for transmitting light and a shielding mode for shielding light.

2. The image projection device according to claim 1, wherein
the image emission unit emits the image light by pulse drive for repeated light ON and OFF, and
in the shutter unit, the transmission mode is selected during an ON period of the pulse drive, and the shielding mode is selected during an OFF period of the pulse drive.

3. The image projection device according to claim 1, wherein
the shutter unit includes a rotating body having a light transmission unit and a light shielding unit, and a drive unit that rotationally drives the rotating body.

4. The image projection device according to claim 1, wherein
the shutter unit is disposed between the image emission unit and the projection optical unit.

5. The image projection device according to claim 1, wherein
the projection optical unit forms an image from the image light at an intermediate image forming position on the optical path, and
the shutter unit is disposed at the intermediate image forming position.

6. The image projection device according to claim 1, wherein
the image emission unit includes a first irradiation area irradiated with a first image and a second irradiation area irradiated with a second image, and
the shutter unit selects the transmission mode or the shielding mode for each of the first irradiation area and the second irradiation area.
